(19) United States
(12) Patent Application Publication
(10) Pub. No.: US 2010/0184886 A1
(43) Pub. Date: Jul. 22, 2010

(54) NITROCELLULOSE BASED DISPERSANT

(76) Inventors: Huiguang Kou, Basel (CH); Frank Oliver Heinrich Pirrung, Binzen (DE); Haiyang Yu, Shanghai (CN); Yinzhi Ma, Shanghai (CN); Petrus Johannes Harbers, Shanghai (CN)

Correspondence Address: BASF Performance Products LLC;Patent Department, 540 White Plains Road, P.O. Box 2005, Tarrytown, NY, 10591, US

(21) Appl. No.: 12/667,693

(22) PCT Filed: Jun. 26, 2008
(86) PCT No.: PCT/EP2008/058159

§ 371 Date: Jan. 5, 2010

(30) Foreign Application Priority Data
Jul. 12, 2007 (EP) 07112312.9

(51) Int. Cl. C09D 11/14; C08G 63/91

(52) U.S. Cl. 524/37; 525/54.21; 525/54.2; 524/35

(57) ABSTRACT

The invention relates to a polysaccharide-g-polyether dispersant represented as a compound of Formula 1 or a mixture of compounds of Formula (I) and Formula (II) wherein, T is the backbone polymer and is a residue of a modified cellulose or chitosan, with a molecular weight of 500-1000,000 g/mol; A and B are each, independently, —O— or —NH—; R is linear or branched —(C₁-C₅₀alkylene)-, arylene, cyclo-C₅-C₈-alkylene, isophoronediyl, or linear or branched —(C₂-C₁₀alkylene)- which is interrupted by phenylene or cyclohexanediyl; P is the residue of a polyether and/or polyester chain with molecular weight between 100 and 10,000 g/mol, n is a number of 1-5000.

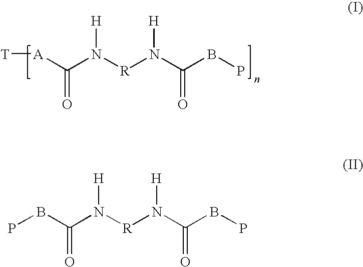

This invention relates to a modified cellulose based dispersant characterized by a “graft onto” approach, which can be used in ink applications.

Dispersants for nitrocellulose (NC) ink system become more and more important because of their profitable effects on the final ink performance, especially on the reduction of viscosity of millbase, which means a higher pigment loading.

Japanese Application JP 58083001 refers to a modified nitrocellulose obtained by reacting an active hydrogen compound with a specified diisocyanate compound and then mixing the resulting reaction product with a nitrocellulose solution. The chemical structure of the nitrocellulose compound obtained is a kind of a blend compound of polyurethane and NC resin. The polyurethane is formed based on diol and diisocyanate, and then the resultant was mixed with NC resin to obtain the blend compound. This blend compound can be used as adhesive in coating a polyester film, and binders for magnetic recording tapes.

M. Barikani et al describe in Carbohydrate Polymers 68 (2007) 773-780 the preparation of starch modified polyurethanes by reacting starch with an urethane prepolymer. The prepolymer was prepared by introducing diisocyanate on both ends of polycaprolactone. The grafting was performed by addition of the prepolymer to starch.

Starch g-polyether materials have almost no dispersion effect.

There is a need to provide a dispersant having improved rheological performance, chromatic strength and transparency in final ink films.

It has now been found that a modified cellulose based dispersant which is characterized by a “graft onto” approach performs lower viscosity of pigment millbase, higher gloss, higher density, and better transparency of final ink films.

Thus, the invention relate to a dispersant represented as compounds of Formula 1 or a mixture of compounds of Formula 1 and Formula 2

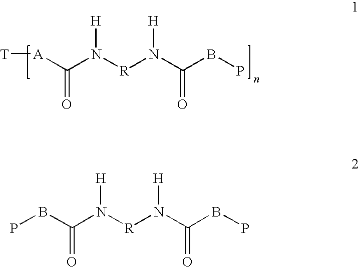

wherein,
T is the backbone polymer and is a residue of a modified cellulose or chitosan, with a molecular weight of 500-1000,000 g/mol;
A and B are each, independently, —O— or —NH—;
R is linear or branched —(C₁-C₅₀alkylene)-, arylene, cyclo-C₅-C₈-alkylene, isophoronediyl, or linear or branched —(C₂-C₁₀alkylene)- which is interrupted by phenylene or cyclohexanediyl;
P is the residue of a polyether and/or polyester chain with molecular weight between 100 and 10,000 g/mol,
n is a number of 1-5000.
   n is preferably a number of 1-2000, more preferably 10-1000.

### DEFINITIONS

The term “modified cellulose” refers to cellulose acetate, cellulose propionate, cellulose nitrate (nitrocellulose), methylcellulose, ethylcellulose, hydroxy ethylcellulose, carboxymethylcellulose, benzylcellulose and the like.

The term “chitosan” refers to deacetylated chitin or (poly)N-glucosamine linked in a beta-1,4 position.

Most preferred is the use of nitrocellulose.

The group R is the linker of the isocyanate groups. Preferred alkylene linkers are C₁-C₂₀ alkylene linkers, more preferred C₁-C₁₀alkylene, mostly preferred C₁-C₆alkylene.

Examples of diisocyanates having an alkylene linker are:

2-methylpentane diisocyanate, 2,2,4-trimethylhexamethylene diisocyanate, hexamethylene diisocyanate. Especially preferred is hexamethylene diisocyanate.

In another embodiment the linker is selected from an arylene such as toluene, 4,4 methylene diphenylene, naphthalene, tetramethyl-m-xylylene. The arylene group may be substituted by methyl.

Examples of diisocyanates having an arylene linker are:

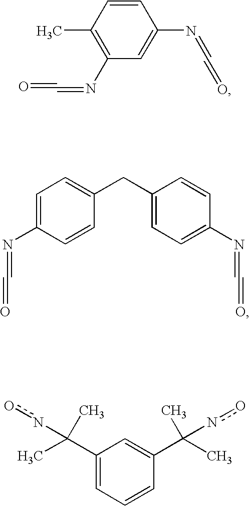

Especially preferred is toluene diisocyanate.

Examples of diisocyanates having a substituted arylene linker are: 3,3′-dimethyl-biphenyl-4,4′-diisocyanate

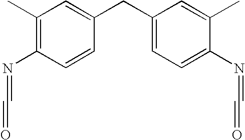

In another embodiment the linker is selected from cycloC₅-C₈alkylene, preferably cyclohexylene such as 4,4 methylene dicyclohexylene, cyclohexanediyl, methylcyclohexanediyl, trimethylcyclohexanediyl methylene.

Examples of diisocyanates having a cycloalkylene linker are:

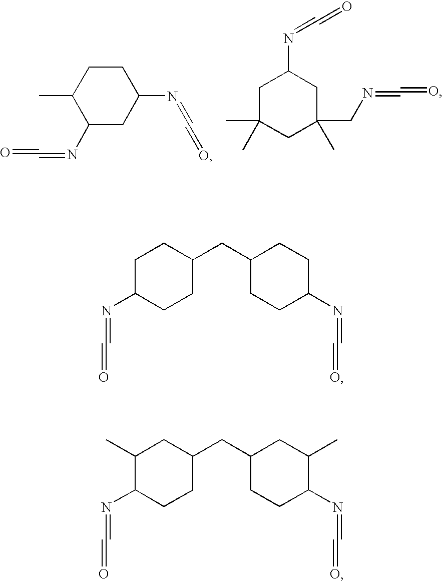

In another embodiment the alkylene linker is interrupted by phenylene or cyclohexanediyl.

Examples of diisocyanates having a linker which is interrupted by phenylene or cyclohexanediyl are:

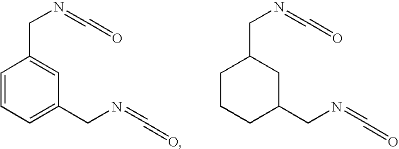

Isophorone diisocyanate is;

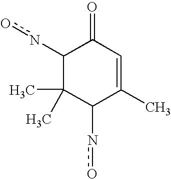

The isocyanates are commercially available.

R is preferably toluenediyl, 4,4 methylene diphenylene, tetramethyl-m-xylylene, hexamethylene, isophoronyl, 4,4 methylene dicyclohexylene.

The term polyether includes linear and branched polyether and containing at least one hydroxyl group (mono-hydroxyl polyether), amine group (mono-amine polyether), imine group (mono imine polyether).

Mono amine polyether are amino terminated polyalkylene glycols, particularly amino terminated polypropylene glycols, polyethylene glycols or copolymers of propylene glycol and ethylene glycol. Commercially available amines are sold under the trade name JEFFAMINE by Huntsman.

Preferred are mono-hydroxyl polyether such as polyethylene glycol mono ether, polypropylene glycol mono ether and mixtures thereof. Non limiting examples are polyethylene glycol methyl ether (MPEG) and polypropylene glycol monobutyl ether.

The term polyester includes linear and branched polyester containing at least one hydroxyl group (mono-hydroxyl polyester). The mono hydroxyl polyester are derived from an aliphatic hydroxy carboxylic acid or a related ester, such as, for example, lactic acid, glycolic acid, or a related lactone such as, for example, ε-caprolactone, δ-glutarolactone, δ-valerolactone, γ-butyrolactone and mixtures, thereof. Preferred are polyester of lactones such as ε-caprolactone or δ-valerolactone.

### Preparation:

The preparation of compounds of Formula 1 or of mixtures of the compounds of Formula 1 and Formula 2 is based on the “graft onto” manufacturing process, characterized by grafting the side chains onto the backbone polymer (T) via graft agent at the present of catalyst, which means the side chain is modified with graft agent first at temperature t₁ and then grafted onto backbone polymer at temperature t₂.

The polymer backbone is a residue of a modified cellulose or chitosan as defined above, with a molecular weight of 500-1000,000 g/mol; preferably nitrocellulose

The side chains are polyether and/or polyester side chains and can be selected from monohydroxyl polyether, mono-hydroxyl polyester, mono-amine or imine polyether, etc, with the molecular weight between 100 and 10,000 g/mol.

The graft agent is a polyisocyanate as described above and is preferably selected from toluene diisocyanate, 4,4 methylene diphenylene diisocyanate, tetramethyl-m-xylylene diisocyanate, hexamethylene diisocyanate, isophorone diisocyanate, 4,4 methylene dicyclohexylene diisocyanate and the like.

The catalyst can be selected from triethylene diamine, triethylamine, dibutyl tin dilaurate etc.

Thus, the process to prepare a compound of the Formula 1 or a mixture of compounds of the Formula 1 and 2 according to claim 1 comprises the steps of

a) reacting the polyisocyanate NCO—R—NCO wherein R is as defined in claim 1 with a polyether and/or polyester at temperature t₁ which ranges from 0° C. to 100° C. in the presence of a catalyst,
b) grafting the obtained modified polyether and/or modified polyester onto the modified cellulose or chitosan backbone at temperature t₂ which ranges from 40° C. to 150° C.

In the two-pot method, step a) is followed by adding the resultant of step a) into another pot containing the modified cellulose or chitosan backbone.

In the one-pot method, step a) is followed by adding the modified cellulose or chitosan backbone into the pot of step a).

A process is thus disclosed to prepare a compound of the Formula 1 or a mixture of compounds of the Formula 1 and 2 as described above wherein the modified polyether and/or modified polyester obtained in step a) is isolated and added to the modified cellulose or chitosan backbone (two-pot method) or wherein the modified cellulose or chitosan backbone is added to the modified polyether and/or modified polyester obtained in step a) (one-pot method).

The molar ratio of graft agent to side chains ranges from 1:1 to 1:2.

The weight ratio of backbone polymer to modified side chains ranges from 5:1 to 1:10.

Dosage of catalyst ranges from 0.05% to 1%.

The molecular weight of the modified cellulose or chitosan backbone is 500-1000,000 g/mol, preferably 1000-500,000 g/mol.

The molecular weight of the polyether and/or polyester side is weight between 100 and 10,000 g/mol, preferably 300-5,000 g/mol.

### Use:

The inventive dispersant is used for organic pigment dispersions, especially in nitrocellulose-alcohol (NC-A), nitrocellulose-ester (NC-E) and Nitrocellulose-alcohol/ester (NC-NE) systems, applied in general coating, ink applications or flexo applications as well as food contact applications.

### Accessibility of the Starting Materials

Abbreviations of chemicals and their suppliers

| ABBREVIATION | CHEMICAL NAME | SUPPLIER |
|---|---|---|
| MPEG | poly(ethylene glycol) methyl ether | Clariant |
| | with different molecular weight | |
| BPPG | poly(propylene glycol) monobutyl | |
| | ether with different molecular weight | |
| Jeffamine | Jeffamine ® M-series | Huntsman |
| | monofunctional amine based on | |
| | poly(ethylene-block-propylene | |
| | glycol) | |
| Surfonamine | Surfonamine ® ML and MNPA | |
| | monofunctional amine based on | |
| | poly(propylene glycol) | |
| NC | nitrocellulose | Hagedorn, |
| EA | ethanol | Wolff |
| IPA | isopropanol | |
| ESO | epoxidized soybean oil | |
| DBP | dibutyl phthalate | |
| ATBC | acetyl tributyl citrate | |
| DOA | dioctyl adipate | |
| CAB | cellulose acetate-butyrate | Eastman |
| CTS | chitosan | Shanghai, |
| | | Nicechem |
| HPMC | Hydroxypropyl Methyl Cellulose | Aldrich |
| HEC | 2-hydroxyethyl cellulose | |
| TDI | toluene diisocyanate | |
| IPDI | isophorone diisocyanate | |
| HDI | hexamethylene diisocyanate | |
| DBTL | dibutyl tin dilaurate | |
| EtoAc | ethyl acetate | |
| MEK | methyl ethyl ketone | |

### EXAMPLES

### Two-Pot Method

### Intermediates

### Intermediate 1

The wetting agent was removed from 100 g nitrocellulose (NC) resin (Walsroder NC-E330 IPA 33%) by vacuum at 70° C., then a 25% wt NC solution was prepared by dissolving the above resultant in 200 g EtOAc with 0.4 g DBTL addition. This is Intermediate 1.

### Intermediate 2

100 g NC resin (Walsroder NC-E330 ESO 20%) with 0.5 g DBTL addition was dissolved in 220 g EtOAc to obtain a 25% wt NC solution, Intermediate 2.

### Intermediate 3-9

Intermediate 3-9 were all prepared in a similar manner as Intermediate 1 except that the type of NC resin was varied as detailed in Table 1 below.

TABLE 1

| Intermediate | NC resin |
|---|---|
| 3 | Walsroder NC-E330 EA 33% |
| 4 | Walsroder NC-E375 IPA 33% |
| 5 | Walsroder NC-E375 EA 33% |
| 6 | Walsroder NC-A300 IPA 33% |
| 7 | Walsroder NC-A400 EA 33% |
| 8 | Walsroder NC-AM330 IPA 33% |
| 9 | BNC NC-E15 IPA 33% (France, BNC) |

### Intermediate 10-22

Intermediate 10-22 were all prepared in a similar manner as Intermediate 2 except that the type of NC resin was varied as detailed in Table 2 below.

TABLE 2

| Intermediate | NC resin |
|---|---|
| 10 | Walsroder NC-E330 DBP 20% |
| 11 | Walsroder NC-E330 ATBC 20% |
| 12 | Walsroder NC-E330 DOA 20% |
| 13 | Walsroder NC-E375 ESO 20% |
| 14 | Walsroder NC-E375 DBP 20% |
| 15 | Walsroder NC-E375 ATBC 20% |
| 16 | Walsroder NC-E375 DOA 20% |
| 17 | Walsroder NC-A300 ESO 20% |
| 18 | Walsroder NC-A400 ESO 20% |
| 19 | Walsroder NC-A300 DBP 20% |
| 20 | Walsroder NC-A400 DBP 20% |
| 21 | Walsroder NC-AM330 ESO 20% |
| 22 | BNC-NC-E15 ESO 20% (Fr, BNC) |

### Intermediate 23

50 g CAB resin (CAB-531-1) with 0.3 g DBTL addition was dissolved in 150 g MEK to obtain a 25% wt solution. This is Intermediate 23.

### Intermediate 24-26

Intermediate 24-26 were all prepared in a similar manner as Intermediate 23 except that the polysaccharide resin was varied as detailed in Table 3 below.

TABLE 3

| Intermediate | polysaccharide resin |
|---|---|
| 24 | CTS |
| 25 | HPMC |
| 26 | HEC |

### Intermediate 27

The mixture of 50.0 g MPEG500 (molecular weight of 500 g/mol), 17.2 g TDI, 0.2 g DBTL, and 68 g EtOAc were stirred under nitrogen at room temperature (RT) for 1 h and at 40° C. for further 3 h. Intermediate 27 was obtained as a 50% wt solution.

### Intermediate 28-45

Intermediate 28-45 were all prepared in a similar manner as Intermediate 27 except that the type and amounts of monofunctional polyether, diisocyanate monomer, amount of EtOAc, and the reaction condition were varied as detailed in Table 4 below. Quantitative EtOAc is added to the reaction formulation to obtain a solution with solid contain of 50% wt. The dosage of DBTL is set as 0.15% wt.

TABLE 4

| | Monofunctional | Diisocyanate | Reaction |
|---|---|---|---|
| Intermediate | polyether | monomer | condition |
| 28 | MPEG1000 | TDI | RT 1 h |
| | 50 g | 8.6 g | 40° C. 3 h |
| 29 | MPEG2000 | TDI | RT 1 h |
| | 100 g | 8.6 g | 40° C. 3 h |
| 30 | BPPG350 | TDI | RT 1 h |
| | 35 g | 17.2 g | 40° C. 3 h |
| 31 | BPPG1000 | TDI | RT 1 h |
| | 50 g | 8.6 g | 40° C. 3 h |
| 32 | BPPG2500 | TDI | RT 1 h |
| | 62.5 g | 4.3 g | 40° C. 3 h |
| 33 | Jaffamine M-600 | TDI | RT 2 h |
| | 60 g | 17.2 g | 40° C. 2 h |
| 34 | Jaffamine M-1000 | TDI | RT 2 h |
| | 50 g | 8.6 g | 40° C. 2 h |
| 35 | Jaffamine M-2005 | TDI | RT 2 h |
| | 50 g | 4.3 g | 40° C. 2 h |
| 36 | Jaffamine M-2070 | TDI | RT 2 h |
| | 50 g | 4.3 g | 40° C. 2 h |
| 37 | Surfonamine ML-300 | TDI | RT 2 h |
| | 30 g | 17.2 g | 40° C. 2 h |
| 38 | Surfonamine MNPA-1000 | TDI | RT 2 h |
| | 50 g | 8.6 g | 40° C. 2 h |
| 39 | MPEG1000 | IPDI | RT 1 h |
| | 50 g | 11.1 g | 60° C. 3 h |
| 40 | BPPG1000 | IPDI | RT 1 h |
| | 50 g | 11.1 g | 60° C. 3 h |
| 41 | Jaffamine M-1000 | IPDI | RT 2 h |
| | 50 g | 11.1 g | 60° C. 2 h |
| 42 | Jaffamine M-2005 | IPDI | RT 2 h |
| | 50 g | 5.6 g | 60° C. 2 h |
| 43 | Surfonamine MNPA-1000 | IPDI | RT 2 h |
| | 50 g | 11.1 g | 60° C. 2 h |
| 44 | BPPG1000 | HDI | RT 1 h |
| | 50 g | 8.4 g | 60° C. 3 h |
| 45 | Surfonamine MNPA-1000 | HDI | RT 2 h |
| | 50 g | 8.4 g | 60° C. 2 h |

### Intermediate 46

The mixture of 13.5 g 1-octadecanol, 36.5 g ε-caprolactone and 0.3 g DBTL were stirred under nitrogen at 170° C. for 6 h, then 60 g EtOAc was added and the resultant was cooled down to RT. 8.6 g TDI was added into the above resultant and stirred under nitrogen at RT for 1 h and at 40° C. for further 3 h. Intermediate 46 was obtained as a 50% wt solution.

### Intermediate 47

The mixture of 13.5 g 1-octadecanol, 36.5 g ε-caprolactone and 0.3 g DBTL were stirred under nitrogen at 170° C. for 6 h, then 62 g EtOAc was added and the resultant was cooled down to RT. 11.1 g IPDI was added into the above resultant and stirred under nitrogen at RT for 1 h and at 60° C. for further 3 h. Intermediate 47 was obtained as a 50% wt solution.

### Intermediate 48

The mixture of 13.5 g 1-octadecanol, 86.5 g ε-caprolactone and 0.6 g DBTL were stirred under nitrogen at 170° C. for 6 h, then 110 g EtOAc was added and the resultant was cooled down to RT. 11.1 g IPDI was added into the above resultant and stirred under nitrogen at RT for 1 h and at 60° C. for further 3 h. Intermediate 48 was obtained as a 50% wt solution.

### Dispersants

### Dispersant 1

Backbone polymer (Intermediate 1) 40.0 g was stirred under nitrogen at 60° C. firstly, and then side chains (Intermediate 27) 13.4 g was dropped into the above resultant slowly. The mixture was cooked at 60° C. for 8 h and 80° C. for further 2 h. Then quantitative EtOAc was removed under vacuum to obtain a yellowish viscous solution (solid contain of 50% wt). This is Dispersant 1.

### Dispersant 2-68

Dispersant 2-68 were all prepared in a similar manner as Dispersant 1 except that the type and amounts of side chains, backbone polymer, and the reaction condition were varied as detailed in Table 5 below.

TABLE 5

| | | Backbone | Reaction |
|---|---|---|---|
| Dispersant | Side chain | polymer | condition |
| 2 | Intermediate 28 | Intermediate 1 | 60° C. 8 h |
| | 23.4 g | 40.0 g | 80° C. 2 h |
| 3 | Intermediate 29 | Intermediate 1 | 60° C. 8 h |
| | 43.4 g | 40.0 g | 80° C. 2 h |
| 4 | Intermediate 30 | Intermediate 1 | 60° C. 8 h |
| | 10.4 g | 40.0 g | 80° C. 2 h |
| 5 | Intermediate 31 | Intermediate 1 | 60° C. 8 h |
| | 23.4 g | 40.0 g | 80° C. 2 h |
| 6 | Intermediate 32 | Intermediate 1 | 60° C. 8 h |
| | 53.4 g | 40.0 g | 80° C. 2 h |
| 7 | Intermediate 33 | Intermediate 1 | 60° C. 8 h |
| | 15.4 g | 40.0 g | 80° C. 2 h |
| 8 | Intermediate 34 | Intermediate 1 | 60° C. 8 h |
| | 23.4 g | 40.0 g | 80° C. 2 h |
| 9 | Intermediate 35 | Intermediate 1 | 60° C. 8 h |
| | 43.4 g | 40.0 g | 80° C. 2 h |
| 10 | Intermediate 36 | Intermediate 1 | 60° C. 8 h |
| | 43.4 g | 40.0 g | 80° C. 2 h |
| 11 | Intermediate 37 | Intermediate 1 | 60° C. 8 h |
| | 9.4 g | 40.0 g | 80° C. 2 h |
| 12 | Intermediate 38 | Intermediate 1 | 60° C. 8 h |
| | 23.4 g | 40.0 g | 80° C. 2 h |
| 13 | Intermediate 39 | Intermediate 1 | 80° C. 12 h |
| | 24.4 g | 40.0 g | |
| 14 | Intermediate 40 | Intermediate 1 | 80° C. 12 h |
| | 24.4 g | 40.0 g | |
| 15 | Intermediate 41 | Intermediate 1 | 80° C. 12 h |
| | 24.4 g | 40.0 g | |
| 16 | Intermediate 42 | Intermediate 1 | 80° C. 12 h |
| | 44.4 g | 40.0 g | |
| 17 | Intermediate 43 | Intermediate 1 | 80° C. 12 h |
| | 24.4 g | 40.0 g | |
| 18 | Intermediate 44 | Intermediate 1 | 80° C. 12 h |
| | 23.4 g | 40.0 g | |
| 19 | Intermediate 45 | Intermediate 1 | 80° C. 12 h |
| | 23.4 g | 40.0 g | |
| 20 | Intermediate 46 | Intermediate 1 | 60° C. 8 h |
| | 23.4 g | 40.0 g | 80° C. 2 h |
| 21 | Intermediate 47 | Intermediate 1 | 80° C. 12 h |
| | 24.4 g | 40.0 g | |
| 22 | Intermediate 48 | Intermediate 1 | 80° C. 12 h |
| | 44.4 g | 40.0 g | |
| 23 | Intermediate 31 | Intermediate 2 | 60° C. 8 h |
| | 23.4 g | 40.0 g | 80° C. 2 h |
| 24 | Intermediate 31 | Intermediate 3 | 60° C. 8 h |
| | 23.4 g | 40.0 g | 80° C. 2 h |
| 25 | Intermediate 31 | Intermediate 4 | 60° C. 8 h |
| | 23.4 g | 40.0 g | 80° C. 2 h |
| 26 | Intermediate 31 | Intermediate 5 | 60° C. 8 h |
| | 23.4 g | 40.0 g | 80° C. 2 h |
| 27 | Intermediate 31 | Intermediate 6 | 60° C. 8 h |
| | 23.4 g | 40.0 g | 80° C. 2 h |
| 28 | Intermediate 31 | Intermediate 7 | 60° C. 8 h |
| | 23.4 g | 40.0 g | 80° C. 2 h |
| 29 | Intermediate 31 | Intermediate 8 | 60° C. 8 h |
| | 23.4 g | 40.0 g | 80° C. 2 h |
| 30 | Intermediate 31 | Intermediate 9 | 60° C. 8 h |
| | 23.4 g | 40.0 g | 80° C. 2 h |
| 31 | Intermediate 31 | Intermediate 10 | 60° C. 8 h |
| | 23.4 g | 40.0 g | 80° C. 2 h |
| 32 | Intermediate 31 | Intermediate 11 | 60° C. 8 h |
| | 23.4 g | 40.0 g | 80° C. 2 h |
| 33 | Intermediate 31 | Intermediate 12 | 60° C. 8 h |
| | 23.4 g | 40.0 g | 80° C. 2 h |
| 34 | Intermediate 31 | Intermediate 13 | 60° C. 8 h |
| | 23.4 g | 40.0 g | 80° C. 2 h |
| 35 | Intermediate 31 | Intermediate 14 | 60° C. 8 h |
| | 23.4 g | 40.0 g | 80° C. 2 h |
| 36 | Intermediate 31 | Intermediate 15 | 60° C. 8 h |
| | 23.4 g | 40.0 g | 80° C. 2 h |
| 37 | Intermediate 31 | Intermediate 16 | 60° C. 8 h |
| | 23.4 g | 40.0 g | 80° C. 2 h |
| 38 | Intermediate 31 | Intermediate 17 | 60° C. 8 h |
| | 23.4 g | 40.0 g | 80° C. 2 h |
| 39 | Intermediate 31 | Intermediate 18 | 60° C. 8 h |
| | 23.4 g | 40.0 g | 80° C. 2 h |
| 40 | Intermediate 31 | Intermediate 19 | 60° C. 8 h |
| | 23.4 g | 40.0 g | 80° C. 2 h |
| 41 | Intermediate 31 | Intermediate 20 | 60° C. 8 h |
| | 23.4 g | 40.0 g | 80° C. 2 h |
| 42 | Intermediate 31 | Intermediate 21 | 60° C. 8 h |
| | 23.4 g | 40.0 g | 80° C. 2 h |
| 43 | Intermediate 31 | Intermediate 22 | 60° C. 8 h |
| | 23.4 g | 40.0 g | 80° C. 2 h |
| 44 | Intermediate 31 | Intermediate 23 | 60° C. 8 h |
| | 23.4 g | 80.0 g | 80° C. 8 h |
| 45 | Intermediate 31 | Intermediate 24 | 60° C. 6 h |
| | 23.4 g | 32.0 g | 80° C. 2 h |
| 46 | Intermediate 31 | Intermediate 25 | 60° C. 8 h |
| | 23.4 g | 32.0 g | 80° C. 8 h |
| 47 | Intermediate 31 | Intermediate 26 | 60° C. 8 h |
| | 23.4 g | 32.0 g | 80° C. 8 h |
| 48 | Intermediate 31 | Intermediate 1 | 60° C. 8 h |
| | 23.4 g | 10.0 g | 80° C. 2 h |
| 49 | Intermediate 31 | Intermediate 1 | 60° C. 8 h |
| | 23.4 g | 20.0 g | 80° C. 2 h |
| 50 | Intermediate 31 | Intermediate 1 | 60° C. 8 h |
| | 23.4 g | 60.0 g | 80° C. 2 h |
| 51 | Intermediate 31 | Intermediate 1 | 60° C. 8 h |
| | 23.4 g | 80.0 g | 80° C. 2 h |
| 52 | Intermediate 31 | Intermediate 2 | 60° C. 8 h |
| | 23.4 g | 10.0 g | 80° C. 2 h |
| 53 | Intermediate 31 | Intermediate 2 | 60° C. 8 h |
| | 23.4 g | 20.0 g | 80° C. 2 h |
| 54 | Intermediate 31 | Intermediate 2 | 60° C. 8 h |
| | 23.4 g | 60.0 g | 80° C. 2 h |
| 55 | Intermediate 31 | Intermediate 2 | 60° C. 8 h |
| | 23.4 g | 80.0 g | 80° C. 2 h |
| 56 | Intermediate 38 | Intermediate 1 | 60° C. 8 h |
| | 23.4 g | 20.0 g | 80° C. 2 h |
| 57 | Intermediate 38 | Intermediate 2 | 60° C. 8 h |
| | 23.4 g | 20.0 g | 80° C. 2 h |
| 58 | Intermediate 40 | Intermediate 1 | 80° C. 12 h |
| | 24.3 g | 20.0 g | |
| 59 | Intermediate 40 | Intermediate 2 | 80° C. 12 h |
| | 24.4 g | 20.0 g | |
| 60 | Intermediate 38 | Intermediate 5 | 60° C. 8 h |
| | 23.4 g | 40.0 g | 80° C. 2 h |
| 61 | Intermediate 40 | Intermediate 5 | 80° C. 12 h |
| | 24.4 g | 40.0 g | |
| 62 | Intermediate 38 | Intermediate 14 | 60° C. 8 h |
| | 23.4 g | 40.0 g | 80° C. 2 h |
| 63 | Intermediate 40 | Intermediate 14 | 80° C. 12 h |
| | 24.4 g | 40.0 g | |
| 64 | Intermediate 40 | Intermediate 14 | 80° C. 12 h |
| | 24.4 g | 20.0 g | |
| 65 | Intermediate 40 | Intermediate 14 | 80° C. 12 h |
| | 24.4 g | 10.0 g | |
| 66 | Intermediate 38 | Intermediate 5 | 60° C. 8 h |
| | 23.4 g | 10.0 g | 80° C. 2 h |
| 67 | Intermediate 38 | Intermediate 5 | 60° C. 8 h |
| | 23.4 g | 20.0 g | 80° C. 2 h |
| 68 | Intermediate 38 | Intermediate 5 | 60° C. 8 h |
| | 23.4 g | 80.0 g | 80° C. 2 h |

### One-Pot Method

### Dispersant 69

The mixture of 50.0 g MPEG500 (molecular weight of 500 g/mol), 17.2 g TDI, 0.2 g DBTL, and 68 g EtOAc were stirred under nitrogen at room temperature (RT) for 1 h and at 40° C. for further 3 h. Then, backbone polymer (Intermediate 1) 400.0 g was added into above resultant and stirred under nitrogen at 60° C. for 8 h and 80° C. for further 2 h. Quantitative EtOAc was removed under vacuum to obtain a yellowish viscous solution (solid contain of 50% wt). This is Dispersant 69.

### Dispersant 70-78

Dispersant 70-78 were all prepared in a similar manner as Dispersant 69 except that the type and amounts of side chains, backbone polymer, and the reaction condition were varied as detailed in Table 6 below.

TABLE 6

| | | Backbone | Reaction |
|---|---|---|---|
| Dispersant | Side chain | polymer | condition |
| 70 | Intermediate 31 | Intermediate 1 | 60° C. 8 h |
| | 23.4 g | 40.0 g | 80° C. 2 h |
| 71 | Intermediate 40 | Intermediate 1 | 80° C. 12 h |
| | 24.4 g | 40.0 g | |
| 72 | Intermediate 44 | Intermediate 1 | 80° C. 12 h |
| | 23.4 g | 40.0 g | |
| 73 | Intermediate 31 | Intermediate 2 | 60° C. 8 h |
| | 23.4 g | 40.0 g | 80° C. 2 h |
| 74 | Intermediate 31 | Intermediate 1 | 60° C. 8 h |
| | 23.4 g | 60.0 g | 80° C. 2 h |
| 75 | Intermediate 31 | Intermediate 2 | 60° C. 8 h |
| | 23.4 g | 20.0 g | 80° C. 2 h |
| 76 | Intermediate 31 | Intermediate 2 | 60° C. 8 h |
| | 23.4 g | 60.0 g | 80° C. 2 h |
| 77 | Intermediate 40 | Intermediate 1 | 80° C. 12 h |
| | 24.3 g | 20.0 g | |
| 78 | Intermediate 40 | Intermediate 2 | 80° C. 12 h |
| | 24.4 g | 20.0 g | |

### Performance Screening

In order to test the dispersion effect of the obtained dispersants, millbase was prepared according to the Formulation 1. The millbase was dispersed in Scandex Shaker for 2.0 h with the help of glass beads, and then filtered and stored at RT overnight. Final ink for testing was based on a NC-A system (Formulation 2). The final ink was prepared via mix with Scandex Shaker for 10 min, and applied on black-white paper with a 12 μm film thickness.

### Formulation 1. Preparation of Millbase

dispersant dosage

| | ingredients (unit in gram) | 0% | 2.5% |
|---|---|---|---|
| 1) | NC medium** | 30.9 | 29.86 |
| 2) | Dispersant (50%) | 0 | 1.04 |

| | | |
|---|---|---|
| 3) | EA | 48.1 |
| 4) | Pigments | 21 |
| 5) | 3.0 mm glass beads | 200 |
| | Total (g) | 300 |

| | | |
|---|---|---|
| Pigments | IRGALITE Yellow BXL, BXFL | Supplied from Ciba |
| | IRGALITE Rubine 4BGL, 4BXL | |
| | IRGALITE Blue GLVO, GLO | |
| | Permanent Yellow PGRL05, 06 | Supplied from Clariant |
| **NC | NC resin A300 EA 33% (Wolff) | 34.5% wt |
| medium | EA | 50.6% wt |
| | EtOAc | 10.0% wt |
| | Dioctyl phathalate | 4.9% wt |

### Formulation 2. Final Ink System

| | | |
|---|---|---|
| 1) | NC medium | 29.4% wt |
| 2) | Millbase | 47.6% wt |
| 3) | EA | 18.4% wt |
| 4) | Ethoxypropanol | 4.6% wt |

The performance of Dispersant 1-68 was tested according to Formulation 1 and 2. In general, some dispersants were taken as the representative dispersants, such as 5, 12, 14, 17, 23, 24, 29, 31-33, 42, 70, 73, and so on. The rheological behavior of the millbase was measured by Thermo-Haake RheoStress 600 equipment (Table 7). It was observed that the millbase flow well and their viscosities were comparable or lower than the blank formulation (dispersant dosage of 0%).

TABLE 7
Rheological data of Millbase

| | IRGALITE | | Permanent | | IRGALITE | | IRGALITE | |
|---|---|---|---|---|---|---|---|---|
| | Yellow | | Yellow | | Rubine | | Blue | |
| | BXL | BXFL | PGRL05 | PGRL06 | 4BGL | 4BXL | GLVO | GLO |
| Blank formulation | 5500 | 4000 | 2850 | 5550 | 2200 | 1600 | 2400 | 16700 |
| Comparative | 12500 | 9050 | 6500 | 9950 | 4500 | 3450 | 7550 | 35400 |
| Example A | | | | | | | | |
| Dispersant 5 | 5300 | 2600 | 2800 | 5400 | 1300 | 900 | 3200 | 15900 |
| Dispersant 12 | 5250 | 2500 | 2850 | 5300 | 1400 | 800 | 3000 | 16000 |
| Dispersant 14 | 5350 | 2550 | 2900 | 5350 | 1200 | 750 | 3100 | 15950 |
| Dispersant 17 | 5300 | 2650 | 2950 | 5450 | 1100 | 900 | 3050 | 16500 |
| Dispersant 23 | 5200 | 2500 | 2850 | 5350 | 1000 | 850 | 3250 | 16000 |
| Dispersant 29 | 5250 | 2450 | 2800 | 5400 | 1200 | 800 | 3100 | 16050 |
| Dispersant 32 | 5300 | 2550 | 2900 | 5450 | 1150 | 900 | 3250 | 16100 |
| Dispersant 42 | 5250 | 2450 | 2850 | 5350 | 1100 | 850 | 3050 | 16000 |
| Dispersant 73 | 5200 | 2550 | 2850 | 5350 | 1050 | 850 | 3250 | 15900 |

η (mPas)
γ = 1.0 (1/s)
Comparative sample A was synthesized according to CN1128274.

The results show that comparative sample A performs worse dispersion effect (viscosity, gloss and opacity) than the blank formulation and than other dispersants, such as Dispersant 5, 14, 32 etc.

Tested in NC-A system, the performance of the dispersants was generally very good with satisfactory results, e.g. high gloss (Table 8), low opacity (Table 9), and high density, etc, compared with blank formulation.

TABLE 8
Gloss (60°) of final ink in NC-A system

| | IRGALITE | | Permanent | | IRGALITE | | IRGALITE | |
|---|---|---|---|---|---|---|---|---|
| | Yellow | | Yellow | | Rubine | | Blue | |
| | BXL | BXFL | PGRL05 | PGRL06 | 4BGL | 4BXL | GLVO | GLO |
| Blank formulation | 50.3 | 63.2 | 52.1 | 50.0 | 70.6 | 85.5 | 54.8 | 17.9 |
| Comparative | 48.4 | 54.3 | 49.5 | 47.3 | 65.4 | 81.1 | 50.3 | 14.7 |
| Example A | | | | | | | | |
| Dispersant 5 | 59.3 | 67.3 | 56.4 | 52.7 | 94.5 | 88.6 | 61.5 | 19.7 |
| Dispersant 12 | 57.8 | 66.0 | 55.7 | 54.2 | 90.7 | 90.3 | 60.6 | 20.2 |
| Dispersant 17 | 60.2 | 67.7 | 56.1 | 55.6 | 97.4 | 93.4 | 59.5 | 18.5 |
| Dispersant 23 | 58.5 | 65.2 | 55.4 | 54.8 | 89.8 | 91.5 | 58.9 | 17.4 |
| Dispersant 32 | 56.9 | 68.3 | 54.7 | 51.6 | 92.4 | 89.4 | 60.3 | 19.2 |
| Dispersant 42 | 57.7 | 66.4 | 57.4 | 54.6 | 93.7 | 90.8 | 61.7 | 21.3 |
| Dispersant 73 | 58.7 | 65.2 | 55.6 | 54.8 | 89.8 | 91.3 | 58.9 | 17.0 |

TABLE 9
Opacity of final ink in NC-A system

| | IRGALITE | | Permanent | | IRGALITE | | IRGALITE | |
|---|---|---|---|---|---|---|---|---|
| | Yellow | | Yellow | | Rubine | | Blue | |
| | BXL | BXFL | PGRL05 | PGRL06 | 4BGL | 4BXL | GLVO | GLO |
| Blank formulation | 4.7 | 5.9 | 5.1 | 4.3 | 18.6 | 18.1 | 6.3 | 18.9 |
| Comparative | 5.2 | 7.0 | 5.9 | 4.8 | 20.3 | 21.6 | 7.8 | 22.6 |
| Example A | | | | | | | | |
| Dispersant 5 | 3.3 | 5.4 | 4.1 | 3.7 | 14.4 | 17.2 | 4.8 | 18.0 |
| Dispersant 12 | 3.1 | 5.0 | 3.7 | 3.4 | 15.1 | 16.4 | 5.3 | 17.4 |
| Dispersant 17 | 3.2 | 5.7 | 4.2 | 3.8 | 13.8 | 17.3 | 4.3 | 18.1 |
| Dispersant 23 | 3.5 | 4.9 | 3.9 | 3.1 | 14.9 | 15.6 | 5.0 | 15.8 |
| Dispersant 32 | 3.7 | 5.1 | 4.0 | 3.5 | 13.9 | 14.7 | 5.2 | 16.5 |
| Dispersant 42 | 3.3 | 5.2 | 3.8 | 3.3 | 15.3 | 13.9 | 4.0 | 15.8 |
| Dispersant 73 | 3.4 | 4.9 | 3.8 | 3.2 | 14.9 | 15.8 | 5.1 | 16.0 |

1. Dispersant represented as a compound of Formula 1 or a mixture of compounds of Formula 1 and Formula 2 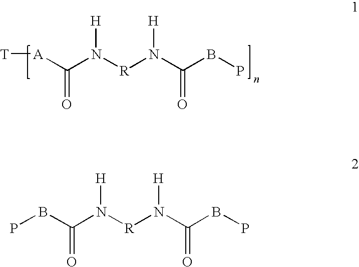
wherein,
T is a polymer backbone and is a residue of a cellulose acetate, cellulose propionate, cellulose nitrate (nitrocellulose), methylcellulose, ethylcellulose, hydroxy ethylcellulose, carboxymethylcellulose, benzylcellulose or chitosan, with a molecular weight of 500-1000,000 g/mol;
A and B are each, independently, —O— or —NH—;
R is linear or branched —(C₁-C₅₀alkylene)-, arylene, cyclo-C₅-C₈-alkylene, isophoronediyl, or linear or branched —(C₂-C₁₀alkylene)- which is interrupted by phenylene or cyclohexanediyl;
P is the residue of a polyether and/or polyester chain with molecular weight between 100 and 10,000 g/mol,
is a number of 1-5000.

2. Dispersant according to claim 1, wherein T is cellulose nitrate (nitrocellulose).

3. Dispersant according to claim 1 wherein R is selected from toluenediyl, 4,4 methylene diphenylene, tetramethyl-m-xylylene, hexamethylenene, isophoronyl and 4,4 methylene dicyclohexylene.

4. Dispersant according to claim 1, wherein P is a mono-hydroxyl polyether.

5. A process to prepare a compound of the Formula 1 or a mixture of compounds of the Formula 1 and 2 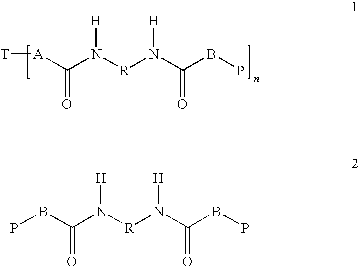
wherein,
T is a polymer backbone and is a residue of a cellulose acetate, cellulose propionate, cellulose nitrate (nitrocellulose), methylcellulose, ethylcellulose, hydroxy ethylcellulose, carboxymethylcellulose, benzylcellulose or chitosan, with a molecular weight of 500-1000,000 g/mol;
A and B are each, independently, —O— or —NH—;
R is linear or branched —(C₁-C₅₀alkylene)-, arylene, cyclo-C₅-C₈-alkylene, isophoronediyl, or linear or branched —(C₂-C₁₀alkylene)- which is interrupted by phenylene or cyclohexanediyl;
P is the residue of a polyether and/or polyester chain with molecular weight between 100 and 10,000 g/mol,
n is a number of 1-5000
which process comprises the steps of
a) reacting a polyisocyanate NCO—R—NCO wherein R is as defined above with a polyether and/or polyester at temperature t₁ which ranges from 0° C. to 100° C. in the presence of a catalyst to obtain a modified polyether and/or modified polyester,
b) grafting the obtained modified polyether and/or modified polyester onto a cellulose acetate, cellulose propionate, cellulose nitrate (nitrocellulose), methylcellulose, ethylcellulose, hydroxy ethylcellulose, carboxymethylcellulose, benzylcellulose or chitosan backbone at temperature t₂ which ranges from 40° C. to 150° C.

6. A process to prepare a compound of the Formula 1 or a mixture of compounds of the Formula 1 and 2 according to claim 5 wherein the modified polyether and/or modified polyester obtained in step a) is isolated and added to the cellulose acetate, cellulose propionate, cellulose nitrate (nitrocellulose), methylcellulose, ethylcellulose, hydroxy ethylcellulose, carboxymethylcellulose, benzylcellulose or chitosan backbone or wherein the cellulose acetate, cellulose propionate, cellulose nitrate (nitrocellulose), methylcellulose, ethylcellulose, hydroxy ethylcellulose, carboxymethylcellulose, benzylcellulose or chitosan backbone is added to the modified polyether and/or modified polyester obtained in step a).

7. A process according to claim 5, wherein the molar ratio of polyisocyanate to the polyether and/or polyester ranges from 1:1 to 1:2 and the weight ratio of backbone polymer to the modified polyether and/or modified polyester ranges from 5:1 to 1:10.

8. An organic pigment dispersion comprising as dispersant the compound of Formula 1 or of the mixture of compounds of the Formula 1 and 2 according to claim 1.

9. (canceled)

10. An organic pigment dispersion according to claim 8 in nitrocellulose-alcohol (NC-A), nitrocellulose-ester (NC-E) or Nitrocellulose-alcohol/ester (NC-NE).

11. A coating or ink comprising the organic pigment dispersion according to claim 8.

12. A coating or ink comprising the organic pigment dispersion according to claim 10.
